(19) United States
(12) Patent Application Publication
(10) Pub. No.: US 2026/0338364 A1
(43) Pub. Date: Oct. 29, 2026

(54) LINE VOLTAGE-OPERATED DEVICE INCLUDING BATTERY-OPERATED LIGHTING FUNCTIONS

(71) Applicant: Feit Electric Company, Inc., Pico Rivera, CA (US)

(72) Inventors: Jose MATA, Pico Rivera, CA (US); James CLARK, Pico Rivera, CA (US); Brian HALLIWELL, Pico Rivera, CA (US); Shane IGO, Pico Rivera, CA (US)

(21) Appl. No.: 19/188,114

(22) Filed: Apr. 24, 2025

(51) Int. Cl. F21V 23/04; F21V 33/00

(52) U.S. Cl. CPC F21V 23/0471; F21V 23/0464; F21V 33/0096

(57) ABSTRACT

A lighting device is provided that includes one or more light engines configured to provide light in a first operating mode and a second operating mode. The one or more light engines emit light of higher luminosity when operating in the first operating mode than when operating in the second operating mode. The lighting device further includes at least one battery configured to provide power to at least one of the one or more light engines when the one or more light engines are providing light in the second operating mode; a motion sensor; and a control unit configured to operate the one or more light engines and receive sensor signals from the motion sensor. The control unit is configured to operate the one or more light engines in the second operating mode using power from the at least one battery responsive to the motion sensor detecting motion.

### BACKGROUND

Existing lighting devices utilize line voltage to power a light engine. The light engine is activated using a switch or a remote. The light engine may remain turned on until the switch or remote indicate to the light engine to turn off. However, when the switch or remote are set to turn the light engine off, the region in which the light engine is installed remains unlit. Therefore, there is a need for providing lighting when a light engine is turned off.

### BRIEF SUMMARY

According to an aspect of the present disclosure, a lighting device is provided. In some embodiments, the lighting device comprises one or more light engines configured to provide light in a first operating mode and a second operating mode. The one or more light engines emit light of higher luminosity when operating in the first operating mode than when operating in the second operating mode. The lighting device further comprises at least one battery configured to provide power to at least one of the one or more light engines when the one or more light engines are providing light in the second operating mode; at least one motion sensor; and a control unit configured to operate the one or more light engines. The at least one rechargeable battery, and the at least one motion sensor, the control unit are in communication with the one or more light engines, the at least one rechargeable battery, and the at least one motion sensor. The control unit is configured to operate the one or more light engines in the second operating mode using power from the at least one battery responsive to the at least one motion sensor detecting motion.

In an example embodiment, the lighting device further includes a physical switch thereon configured to control a detection distance of the at least one motion sensor.

In an example embodiment, the at least one battery is a rechargeable battery configured to recharge while the one or more light engines are being operated in the first operating mode.

In an example embodiment, the at least one motion sensor is configured to (a) detect motion within a predetermined region, and (b) indicate to the control unit to activate the at least one of the one or more light engines in the second operating mode based on detecting motion within the predetermined region.

In an example embodiment, the at least one motion sensor is activated when the one or more light engines are not being operated in the first operating mode.

In an example embodiment, the control unit is configured to stop operating the at least one of the one or more light engines in the second operating mode after a predetermined time period has elapsed since operation of the at least one of the one or more light engines in the second operating mode was initiated.

In an example embodiment, the lighting device further includes a shield configured to limit a field of view of the at least one motion sensor.

In an example embodiment, the lighting device further includes photosensor configured to detect an ambient light level in a space where the lighting device is located, wherein the control unit is configured to cause operation of the at least one of the one or more light engines in the second operation mode responsive to the at least one motion sensor detecting motion when the ambient light level detected by the photosensor is less than a threshold light level.

In an example embodiment, the lighting device further includes at least one additional functional component, wherein the control unit is configured to, at least in part, control operation of the at least one additional functional component.

In an example embodiment, the at least one additional functional component is a vent fan.

In an example embodiment, the one or more light engines are operated in the first operating mode using line voltage and the at least one additional functional component is operated using line voltage.

According to another aspect, a vent fan system is provided. In an example embodiment, the vent fan system includes a vent fan; a lighting device; and a control unit. The lighting device includes one or more light engines configured to provide light in a first operating mode and a second operating mode. The one or more light engines emit light of higher luminosity when operating in the first operating mode than when operating in the second operating mode. The lighting device further includes at least one battery configured to provide power to at least one of the one or more light engines when the one or more light engines are providing light in the second operating mode; and at least one motion sensor. The control unit is configured to operate the one or more light engines and the vent fan, the at least one rechargeable battery, and the at least one motion sensor, the control unit in communication with the one or more light engines, the at least one rechargeable battery, and the at least one motion sensor, wherein the control unit is configured to operate the at least one of the one or more light engines in the second operating mode using power from the at least one battery responsive to the at least one motion sensor detecting motion.

In an example embodiment, the vent fan system further includes a shield configured to limit a field of view of the at least one motion sensor.

In an example embodiment, the vent fan system further includes photosensor configured to detect an ambient light level in a space where the lighting device is located, wherein the control unit is configured to cause operation of the at least one of the one or more light engines in the second operation mode responsive to the at least one motion sensor detecting motion when the ambient light level detected by the photosensor is less than a threshold light level.

In an example embodiment, the vent fan system further includes a physical switch thereon configured to control a detection distance of the at least one motion sensor.

In an example embodiment, the at least one battery is a rechargeable battery configured to recharge while the one or more light engines are being operated in the first operating mode.

In an example embodiment, the at least one motion sensor is configured to (a) detect motion within a predetermined region, and (b) indicate to the control unit to activate the at least one of the one or more light engines in the second operating mode based on detecting motion within the predetermined region.

In an example embodiment, the at least one motion sensor is activated when the one or more light engines are not being operated in the first operating mode.

In an example embodiment, the control unit is configured to stop operating the at least one of the one or more light engines in the second operating mode after a predetermined time period has elapsed since operation of the at least one of the one or more light engines in the second operating mode was initiated.

In an example embodiment, the one or more light engines are operated in the first operating mode using line voltage and the at least one additional functional component is operated using line voltage.

According to another aspect, a method for operating a lighting device is provided. In an example embodiment, the method includes setting, by a control unit, a state of a first operating mode of one or more light engines of a lighting device to an OFF state; activating, by the control unit, at least one motion sensor based on the first operating mode of the one or more light engines being in the OFF state; detecting, by the at least one motion sensor, motion within a predetermined region; setting, by the control unit and based on the at least one motion sensor detecting motion, a state of a second operating mode of the one or more light engines of the lighting device to an ON state, wherein the one or more light engines are configured emit light of higher luminosity when operating in the first operating mode than when operating in the second operating mode; and setting, after a predetermined time period has elapsed, the second operating mode to the OFF state.

In an example embodiment, the method further includes, while at least one of the first operating mode or at least one additional functional component is set to an ON state, causing charging of a rechargeable battery of the lighting device configured to provide power to at least one of the one or more light engines when the second operating mode is set to the ON state.

In an example embodiment, the method further includes, prior to setting the state of the second operating mode to the ON state, determining that an ambient light level in a space in which the lighting device is located is less than a threshold light level based at least in part on a photosensor of the lighting device.

According to another aspect, a device is provided. The device includes one or more functional components configured to be operated via application of line voltage to the device; at least one light engine; at least one rechargeable battery configured to power to at least one light engine in an auxiliary lighting operating mode; at least one motion sensor; at least one light sensor; and a control unit. The control unit is configured to control operation of the one or more functional components, the at least one light engine, the at least one rechargeable battery, the at least one motion sensor, and the at least one light sensor. For example, the control unit is configured to, responsive to line voltage not being applied to the device, the at least one light sensor indicating an ambient light threshold is satisfied, and the at least one motion sensor indicating that motion was detected within a predetermined area, operate the at least one light engine in the auxiliary lighting operating mode using power from the at least one rechargeable battery responsive to the at least one motion sensor detecting motion.

In an example embodiment, the control unit is configured to stop operating the at least one light engine in the auxiliary lighting operating mode after a predetermined time period has elapsed since operation of the at least one light engine in the auxiliary lighting operating mode was initiated.

### BRIEF DESCRIPTION OF THE SEVERAL VIEWS OF THE DRAWINGS(S)

Having thus described the disclosure in general terms, reference will now be made to the accompanying drawings, which are not necessarily drawn to scale, and wherein:

FIG. 1A illustrates an exemplary perspective view of a lighting device in accordance with various embodiments of the present disclosure;

FIG. 1B illustrates an exemplary cross-sectional view of an example lighting device in accordance with various embodiments of the present disclosure;

FIG. 1C illustrates an exemplary cross-sectional view of an example light engine in accordance with various embodiments of the present disclosure;

FIG. 2 illustrates an exemplary block diagram of an example lighting device that is a vent fan, in accordance with various embodiments of the present disclosure;

FIGS. 3A-3F illustrate various views of an example lighting device that is a vent fan, in accordance with various embodiments of the present disclosure;

FIG. 4 illustrates an exemplary block diagram of at least a portion of the circuitry of an example lighting device, in accordance with various embodiments of the present disclosure;

FIG. 5 illustrates a flowchart that illustrates operation of a lighting device, in accordance with certain embodiments;

FIG. 6 illustrates an exemplary block diagram of at least some electrical components of a lighting device in accordance with various embodiments of the present disclosure;

FIG. 7 illustrates an exemplary block diagram of a remote switch in communication with a lighting device in accordance with various embodiments of the present disclosure; and

FIG. 8 illustrates an exemplary block diagram of a computing entity that may be used as a remote switch in communication with a lighting device in accordance with various embodiments of the present disclosure.

### DETAILED DESCRIPTION OF VARIOUS EMBODIMENTS

The present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein; rather, these embodiments are provided so that this disclosure will satisfy applicable legal requirements. Like numbers refer to like elements throughout.

As used herein, terms such as “front,” “rear,” “top,” “bottom,” etc. are used for explanatory purposes in the examples provided below to describe the relative positions of certain components or portions of components. As used herein, the term “or” is used in both the alternative and conjunctive sense, unless otherwise indicated. The term “along,” and similarly utilized terms, means near or on, but not necessarily requiring directly on an edge or other referenced location.

As used herein, terms “approximately,” “generally,” and “substantially” refer to within manufacturing and/or engineering design tolerances for the corresponding materials and/or elements unless otherwise indicated. The use of such terms is inclusive of and is intended to allow independent claiming of specific values listed. Thus, use of any such aforementioned terms, or similarly interchangeable terms, should not be taken to limit the spirit and scope of embodiments of the present disclosure. As used in the specification and the appended claims, the singular form of “a,” “an,” and “the” include plural references unless otherwise stated. The terms “includes” and/or “including,” when used in the specification, specify the presence of stated feature, elements, and/or components; it does not preclude the presence or addition of one or more other features, steps, operations, elements, components, and/or groups thereof.

As used herein, the phrases “in one embodiment,” “according to one embodiment,” “in some embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment. As used herein, the terms “example,” “exemplary,” and the like are used to “serving as an example, instance, or illustration.” Any implementation, aspect, or design described herein as “example” or “exemplary” is not necessarily to be construed as preferred or advantageous over other implementations, aspects, or designs. Rather, use of the terms “example,” “exemplary,” and the like are intended to present concepts in a concrete fashion.

Aspects of the present disclosure may be implemented as computer program products that comprises articles of manufacture. Such computer program products may include one or more software components including, for example, applications, software objects, methods, data structure, and/or the like. A software component may be coded in any of a variety of programming languages. An illustrative programming language may be a lower-level programming language such as an assembly language associated with a particular hardware architecture and/or operating system platform/system.

Other example of programming languages included, but are not limited to, a macro language, a shell or command language, a job control language, a script language, a database query, or search language, and/or report writing language. In one or more example embodiments, a software component comprising of instructions in one of the foregoing examples of programming languages may be executed directly by an operating system or other software component without having to be first transformed into another form. A software component may be stored as a file or other data storage methods. Software components of a similar type or functionally related may be stored together such as, for example, in a particular directory, folder, or library. Software components may be static (e.g., pre-established, or fixed) or dynamic (e.g., created or modified at the time of execution).

Additionally, or alternatively, aspects of the present disclosure may be implemented as a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media may include all computer-readable media (including volatile and non-volatile media).

In one aspect, a non-volatile readable storage may include a floppy disk, flexible disk, hard disk, solid-state storage (SSS) (e.g., a solid-state drive (SSD), solid state card (SSC), solid state module (SSM) , enterprise flash drive, magnetic tape, and/or the like. A non-volatile computer-readable storage medium may also include compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one aspect, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where aspects are described to use a computer-readable storage medium, other types of computer-readable storage media may be substituted for or used in addition to the computer-readable storage media described above.

Aspects of the present disclosure are described below with reference to block diagrams and flowchart illustrations. Thus, it should be understood that each block of the block diagrams and flowchart illustrations may be implemented in the form of a computer program product, a solely hardware aspect, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some embodiments, retrieval, loading, and/or execution may be performed in parallel such that multiple instructions are retrieved, loaded, and/or executed together. Thus, such aspects can produce specifically configured machines performing the steps or operations specified in the block diagrams and flowchart illustrations. Accordingly, the block diagrams and flowchart illustrations support various combinations of aspects for performing the specified instructions, operations, or steps.

As should be appreciated, various aspects of the present disclosure may also be implemented as methods, apparatuses, systems, computing devices, computing entities, and/or the like. As such, aspects of the present disclosure may take the form of a data structure, apparatus, system, computing device, computing entity, and/or the like executing instructions stored on a computer-readable storage medium to perform certain steps or operations. Thus, aspects of the present disclosure may also take the form of an entirely hardware aspect, an entirely computer program product aspect, and/or an aspect that comprises combination of computer program products and hardware performing certain steps or operations.

The figures are provided to illustrate some examples of the disclosure described. The figures are not to limit the scope of the present embodiment of the disclosure or the appended claims. Aspects of the example embodiment are described below with reference to example applications for illustration. It should be understood that specific details, relationships, and methods are set forth to provide a full understanding of the example embodiment. One of ordinary skill in the art recognize the example embodiment can be practice without one or more specific details and/or with other methods.

### General Overview

In various embodiments, a device is provided. The device includes one or more functional components configured to be operated via application of line voltage to the device. For example, the one or more functional components may include one or more light engines configured to provide one or more lighting functions and/or be operated in one or more operating modes when line voltage is applied to the device. In another example, the one or more functional components include a fan (e.g., a ceiling fan, a vent fan, and/or the like) configured to be operated via application of line voltage to the device. Another example of the one or more functional components is a speaker. In certain embodiments, the device may include various combinations of one or more light engines, a fan, one or more speakers, and/or other functional component.

In various embodiments, control of whether line voltage is applied to the device is controlled via a remote switch. For example, the remote switch may be a wall-mounted toggle switch (e.g., a light switch). In some embodiments, the remote switch is part of a building control system (e.g., a digital addressable lighting interface (DALI)-based building control system).

In various embodiments, the device further includes at least one light engine (which might be part of the one or more light engines when the device includes one or more light engines as part of the one or more functional components), at least one rechargeable battery configured to power to at least one light engine in an auxiliary lighting operating mode, at least one motion sensor, at least one light sensor, and a control unit. The control unit is configured to control operation of the one or more functional components, the at least one light engine, the at least one rechargeable battery, the at least one motion sensor, and the at least one light sensor. For example, the control unit is configured to, responsive to line voltage not being applied to the device, the at least one light sensor indicating an ambient light threshold is satisfied, and the at least one motion sensor indicating that motion was detected within a predetermined area, operate the at least one light engine in the auxiliary lighting operating mode using power from the at least one rechargeable battery responsive to the at least one motion sensor detecting motion. For example, the auxiliary lighting operating mode may be a low intensity light such as a night light. For example, the ambient light threshold may be satisfied when the ambient light level detected by the at least one light sensor is less than a threshold brightness, luminosity, or light level.

In an example embodiment, the control unit is configured to stop operating the at least one light engine in the auxiliary lighting operating mode after a predetermined time period has elapsed since operation of the at least one light engine in the auxiliary lighting operating mode was initiated and/or since the at least one motion sensor last detected motion.

Example embodiments of the present disclosure provide a lighting device having one or more light engines, at least one battery, at least one motion sensor, at least one control unit, and/or at least one additional functional component. In various embodiments, the one or more light engines may be operated in a first operating mode or in a second operating mode. When operating in the first operating mode, the one or more light engines are configured to emit light of a higher luminosity than when the one or more light engines are operating in the second operating mode. For example, the first operating mode may be a normal operating mode and the second operating mode (e.g., an auxiliary light operating mode) may be a night light mode. In various embodiments, the one or more light engines are power by line voltage when operating in the first operating mode and powered by a rechargeable battery of the lighting device when operating in the second operating mode. The rechargeable battery may be recharged via line voltage when the one or more light engines are being operated in the first operating mode.

In an example embodiment, the one or more light engines comprise at least one primary light engine and at least one secondary light engine. In an example embodiment, the lighting fixture is configured to operate/power the at least one primary light engine via line voltage when operating in the first operating mode and the lighting fixture is configured to operate/power the at least one secondary light engine via the at least one battery when operating in the second operating mode. In an example embodiment, the at least one secondary light engine is at least one of the primary light engines and is operated to emit light at a lower luminosity when being operated in the second operating mode compared to when being operated in the first operating mode. In an example embodiment, the at least one secondary light engine is a physically different light engine than the at least one primary light engine.

In an example embodiment, the at least one battery is a rechargeable battery. In an example embodiment, the control unit may be configured to operate the at least one secondary light engine using power from the at least one battery. In an example embodiment, the at least one additional functional component may be a fan (e.g., a vent fan, ceiling fan, desktop fan, etc.), a speaker (e.g., a Bluetooth speaker or other wireless speaker), and/or the like. In various embodiments, the lighting device may comprise a physical switch configured to assist with operating the control unit. In various embodiments, the at least one primary light engine and/or the at least one additional functional component may be operated using line voltage. For example, the at least one switch may control when and/or whether the lighting device is receiving and/or in communication with line voltage.

In various embodiments, the at least one battery is configured to recharge while the at least one primary light engine is turned on (e.g., set to an ON state such that the lighting device is receiving and/or is in communication with line voltage). In an example embodiment, a motion sensor may be configured to detect motion in a region (e.g., a predetermined region, a room, a region within a circle of a certain radius, etc.), for example, while the at least one primary light engine is turned off (e.g., set to an OFF state such that the lighting device is not receiving and/or is not in communication with line voltage). In an example embodiment, the motion sensor may be configured to indicate to the control unit to activate the at least one secondary light engine based on detecting motion in the region. In an example embodiment, a sensor (e.g., a microwave sensor, the motion sensor, and/or the like) may be configured to activate the at least one secondary light engine. In an example embodiment, the at least one secondary light engine may be activated (e.g., turned on) based on the motion sensor detecting motion while the at least one primary light engine is turned off. In an example embodiment, the at least one secondary light engine may remain turned on for a predetermined time (e.g., until a certain period of time has elapsed). In an example embodiment, the at least one secondary light engine may turn off after the predetermined time, for example, unless the motion sensor detects motion again.

### Example Lighting Device

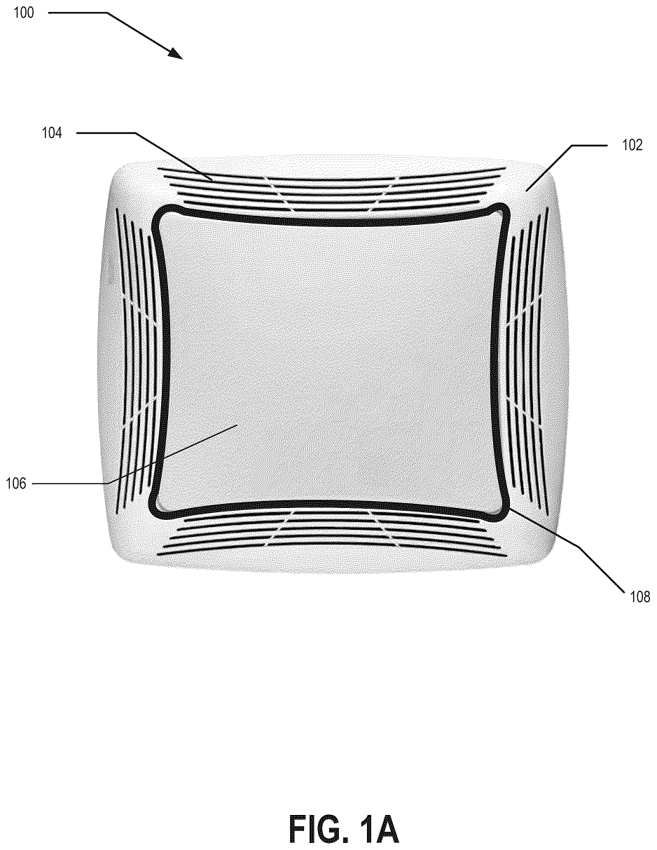

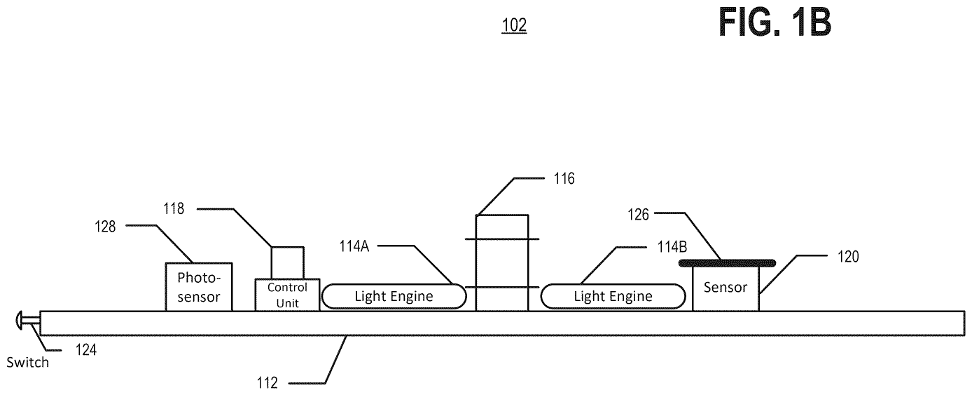

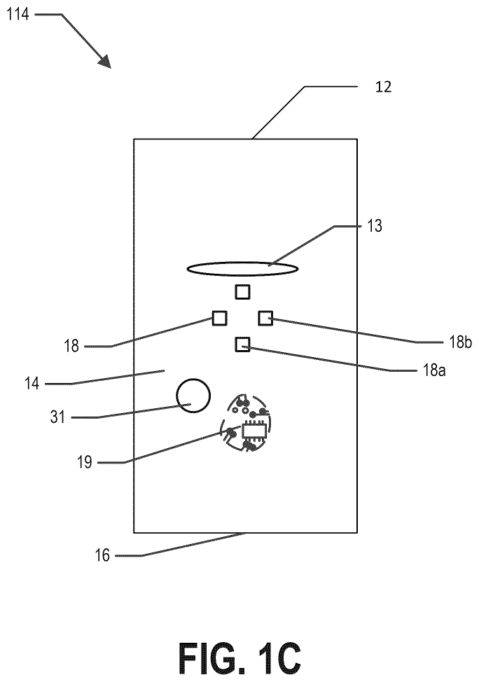

FIG. 1A provides an example perspective view of an example lighting device 100 in accordance with an example embodiment of the present disclosure. In an example embodiment, the example lighting device comprises at least one housing 102, at least one additional functional component 104 (e.g., vent fan, ceiling fan, desktop/tabletop fan, speaker, etc.), at least one primary light engine 106, and/or at least one secondary light engine 108. In various embodiments, the at least one secondary light engine 108 may be configured to surround at least a portion of a perimeter of the at least one primary light engine 106. FIG. 1B provides an example cross-sectional view of the at least one housing 102 of the lighting device, wherein the housing 102 may be configured to store one or more light engines 114A, 114B (collectively “114”), an additional function controller 116, at least one control unit 118, one or more sensors 120 and/or the like. In certain embodiments, a shield 126 is disposed behind a sensor 120 (e.g., between the sensor 120 and the housing 102). For example, microwave motion sensor may be able to detect motion in front of the motion sensor and behind the motion sensor. The shield 126 is configured to limit the field of view of the sensor 120 such that motion from behind the sensor 120 (e.g., likely originating on the other side of a wall or ceiling to which the lighting device is mounted) does not trigger the sensor 120.

In various embodiments, the housing 102 may comprise a covering 112, wherein the covering 112 may be configured to be at least partially transparent/opaque, wherein light from the one or more light engines 114 are capable of passing through the covering 112. In some embodiments, the housing 110 may further comprise a physical switch 124 configured to assist with operating the control unit 118. In an example embodiment, the physical switch 124 enables a user to provide user input to set a detection distance and/or a predetermined region within which motion will be detected. For example, in some scenarios a user may select, via the physical switch 124, the detection distance to be ten feet and in other scenarios a user select, via the physical switch 124, the detection distance to be twenty feet or thirty feet, for example.

In certain embodiments, the lighting device includes a photosensor 128 configured to detect an ambient light level in a space in which the lighting device is located. In some embodiments, the motion sensor is activated or the initiation/activation of the one or more light engines in the second operating mode responsive to the detection of motion is performed when the state of the first operating mode is set to an OFF state (e.g., a wall switch configured to operate the lighting device is turned off such that line voltage is not being provided to the lighting device). In some embodiments, the motion sensor is activated or the initiation/activation of the one or more light engines in the second operating mode responsive to the detection of motion is performed when the state of the first operating mode is set to an OFF state and the ambient light level detected by the photosensor 128 is less than a threshold light level. For example, the control unit may use the ambient light level detected by the photosensor 128 to prevent operating the one or more light engines in the second operating mode (e.g., a night light mode) when the ambient light level is high such that the battery is not unnecessarily discharged.

FIG. 1C provides a partial cutaway perspective view of an example light engine 114 in accordance with an example embodiment of the present disclosure. In various embodiments, the one or more light engines 114 may include a housing 12, optics 13, a base portion 16, two or more light packages 18a, 18b (collectively “18”), driver circuitry 19, a control unit 31, and/or the like. In example embodiments, the housing 12 may be transparent, translucent, and/or semi-translucent and configured to enclose the optical components (e.g., the two or more light packages 18, optics 13, and/or the like). In example embodiments, the housing 12 may be configured to house the driver circuitry 19, control unit 31, a heat sink, heat dissipation elements (e.g., fins, radiators, and/or the like), and/or other elements of the light.

In various embodiments, a light engine is hardwired into the lighting device 100. With further reference to FIG. 1C, in various embodiments, an example light engine 114 includes a light emitting diode (LED) module and/or LED package comprising one or more LED chips. In an example embodiment, the one or more LED chips are mounted on one or more circuit boards. For example, in an example embodiment, the LED chip(s) and/or circuit board(s) to which the LED chip(s) is mounted, is hardwired into the lighting device 100. In an example embodiment, a light engine 114 is an LED package including one or more LED chips; an enclosure enclosing the one or more LED chips (e.g., electrically and/or environmentally isolating the one or more LED chips from an external environment); electrical contacts (e.g., leads and/or traces on the one or more circuit boards); phosphor (e.g., in the case where the emitted light is white light); an encapsulant configured to protect the LED chips, wire bonds, and phosphor; and, optionally, an optical element configured to one or more light aspects or qualities (e.g., power, brightness, color temperature, CRI, and/or the like) and/or dispersion/focus of light emitted by the LED package. In an example embodiment, the light engine 114 includes one or more LED packages and may further include one or more additional optical elements, one or more heat sink components, and/or electronic components (e.g., driver circuitry 19 and/or the like).

In an example embodiment where the one or more LED chips of respective light engines 114 are mounted to one or more circuit boards, components of the driver circuitry 19 and/or the control unit 31 may also be mounted to the one or more circuit boards.

In an example embodiment, a light engine is removably coupled (e.g., via socket) to the lighting device 100. The base portion 16 may be configured for physically securing the light engine 114 into a socket of a lighting device and electrically connecting the driver circuitry 19, control unit 31, and/or other electrical component of the light engine 114 to the socket such that the light engine 114 may be electrically powered through the socket. In example embodiments, the base portion 16 and/or the light engine 114 may be the size of a traditional/standard incandescent lamp. For example, the base portion 16 and/or the light engine may be sized according to an A15, A19, A21, A22, B8, B10, C7, C9, C11, C15, F10, F15, F20 and/or traditional/standard lamp size. In various embodiments, the size of the light engine 114 may vary based as appropriate for the application.

### Example Vent Fans Comprising Lighting Engines

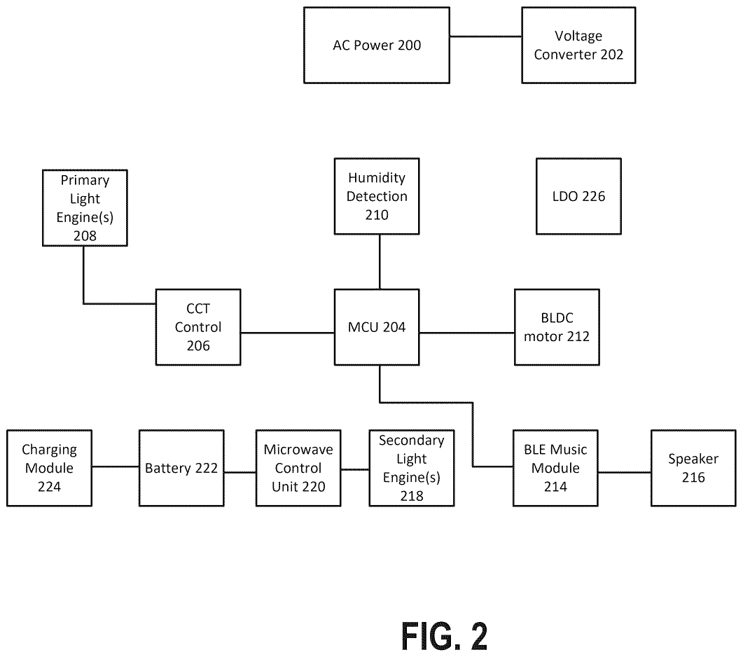

FIG. 2 provides a block wiring diagram of an example lighting device that is a vent fan comprising one or more lighting engines. For example, the lighting device corresponding to FIG. 2 includes additional functional components such as a vent fan and a speaker. The connections depicted in FIG. 2 represent logical connections and may not necessarily depict physical connections.

The electrical components of the example vent fan may comprise an AC power source 200. The AC power source 200 is configured to be in electrical communication with line voltage (e.g., when a corresponding switch is in an ON position). The AC power source 200 is configured to receive an AC current provided by the line voltage and convert the AC current into a DC current characterized by a first (DC) voltage. In an example embodiment, the first voltage is 24 V. In an example embodiment, the AC power source 200 is configured to provide a first electrical signal of the first (DC) voltage to one or more of BLDC motor 212, primary light engine(s) 208, and the voltage converter 202.

In various embodiments, the AC power source 200 is in electrical communication with a voltage converter 202. The voltage converter 202 may be a DC voltage converter. In various embodiments, the voltage converter 202 converts the voltage signal of the first (DC) voltage to a second electrical signal of a second (DC) voltage. In an example embodiment, the second (DC) voltage is 5 V. For example, the voltage converter 202 converts the first electrical signal to the second electrical signal by converting the first voltage of the first electrical signal to the second voltage of the second electrical signal. In various embodiments, the voltage converter 202 is configured to provide a second electrical signal of the second (DC) voltage to a low dropout regulator (LDO) 226, BLDC motor 212, the charging module 224, and the BLE music module 214.

The electrical components of the example vent fan may comprise a microcontroller unit (MCU) 204. The MCU 204 may receive power from the AC power source 200. In an example embodiment, the MCU 204 may be in electrical communication with a correlated color temperature (CCT) control unit 206, a humidity detection unit 210, a brushless DC (BLDC) motor 212 and/or a Bluetooth Low Energy (BLE) music module 214. For example, the microcontroller 204 may be configured to receive and/or provide electrical signals to/from LDO 226, CCT control unit 206, BLDC motor 212, humidity detection unit 210, BLE music module 214, and/or the like. For example, the MCU 204 may control operation of the CCT control unit 206, BLDC motor 212, and/or BLE music module 214 based at least in part on electrical signals received from LDO 226, humidity detection unit 210, BLE music module 214).

The CCT control unit 206 may be configured to determine and/or set a color temperature of one or more primary light engines 208. The humidity detection unit 210 may be configured to detect a humidity level of a region and/or transmit information related to the detected humidity (e.g., for receipt by the MCU 204). The BLDC motor 212 may be configured to operate at least one functional component (e.g., a vent fan). The BLE music module 214 may be in electrical communication with a speaker 216. For example, the BLE music module 214 may be configured to receive a Bluetooth or other wireless communication signal and based thereon, cause the speaker 216 to audibly provide music and/or other audio.

The low-dropout regulator (LDO) 226 may be a voltage regulator. The LDO 226 configured to maintain a predetermined voltage.

Notably, the AC power source 200 and the voltage converter 202 are configured to power various components of the vent fan (e.g., primary light engine(s) 208, BLDC motor 212, BLE music module 214, speaker 216, charging module 224, etc.) when a switch configured to control supply of line voltage to the vent fan is in the ON position. When the switch configured to control supply of line voltage to the vent fan is in the OFF position, the AC power source 200 and the voltage converter 202 are not able to power the various components of the vent fan. However, the battery 222 does provide power for operation of the microwave control unit 220 and the secondary light engine(s) 218.

For example, the electrical components of the example vent fan may comprise one or more secondary light engines 218, a microwave control unit 220, a battery 222, and/or a charging module 224. The microwave control unit 220 may be a microwave motion sensor module configured to detect motion with a region (e.g., a predetermined region, a room, a region within a circle of a certain radius, etc.). While a microwave control unit 220 is used as the motion detector of the illustrated embodiments, various types of motion sensors may be used in various embodiments, as appropriate for the application.

The battery 222 may be configured to provide power to the one or more secondary light engines 218 and the microwave control unit 220. For example, when the vent fan is not in communication with line voltage (e.g., the switch configured to control supply of line voltage to the vent fan is in the OFF position), the microwave control unit 220 is powered by the battery 222 to detect motion within a region. When the microwave control unit 220 detects motion, the microwave control unit 220 causes the one or more secondary light engines 218 to be powered (e.g., by electric power stored in the battery 222).

In an example embodiment, the battery 222 is a rechargeable battery. The charging module 224 is configured to recharge the battery 222. In an example embodiment, the charging module 224 is configured to recharge the battery 222 during a time when the one or more primary light engines 208 are turned on (e.g., set to an ON state). The one or more secondary light engines 218 may be configured to turn on during a time when the one or more primary light engines 208 are turned off (e.g., set to an OFF state), for example, based on motion detected by a motion sensor. In an example embodiment, the one or more secondary light engines 218 may be configured to turn off after a predetermined time period has elapsed. In an example embodiment, the one or more secondary light engines 218 may function as night light(s). For example, motion may be detected within a region, which may trigger the one or more secondary light engines 218 to be turned on. In this example, the one or more secondary light engines 218 may remain on until, for example, 60 seconds pass, at which point the one or more secondary light engines 218 may turn off.

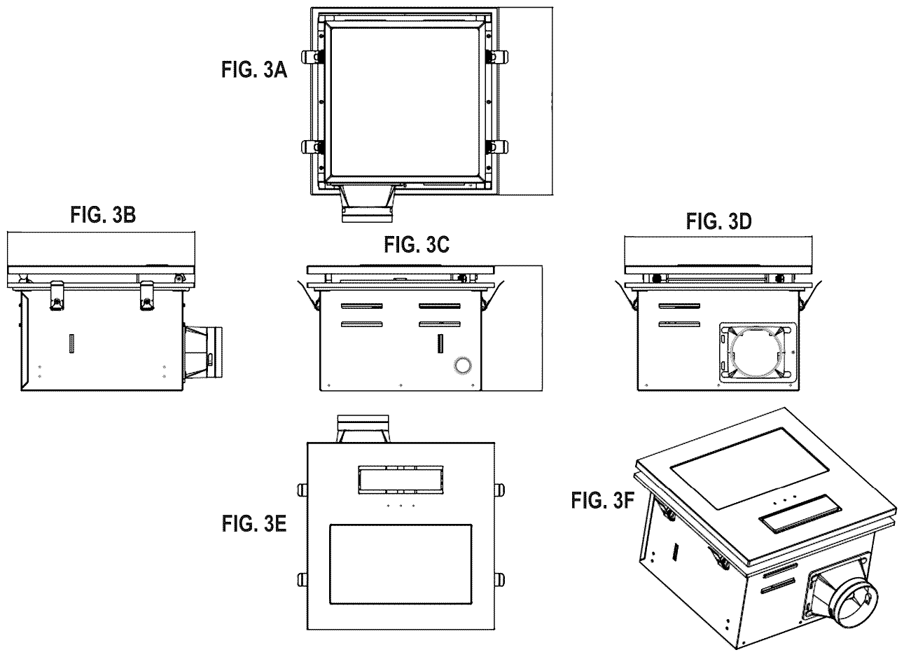

FIGS. 3A-3F provide various perspective views of a vent fan comprising one or more lighting devices. FIG. 3A is a bottom-up view of the vent fan. FIG. 3B is a side view of the vent fan. FIG. 3C is a back view of the vent fan. FIG. 3D is a front view of the vent fan. FIG. 3E is a top-down view of the vent fan. FIG. 3F is a perspective view of the vent fan. The vent fan of FIGS. 3A-3F, in some examples, comprises one or more lighting devices, such as the one or more primary light engines 208 and/or the one or more secondary light engines 218. The vent fan of FIGS. 3A-3F may be an implementation of the lighting device 100. The vent fan of FIGS. 3A-3F may comprise a housing, electrical components, a switch, a motor, at least one light engine (e.g., one or more primary light engines and one or more secondary light engines), and/or at least one additional functional component (e.g., a speaker). The vent fan of FIGS. 3A-3F may be a ceiling vent fan and/or a wall vent fan, as suitable for applications.

### Other Example Lighting Devices

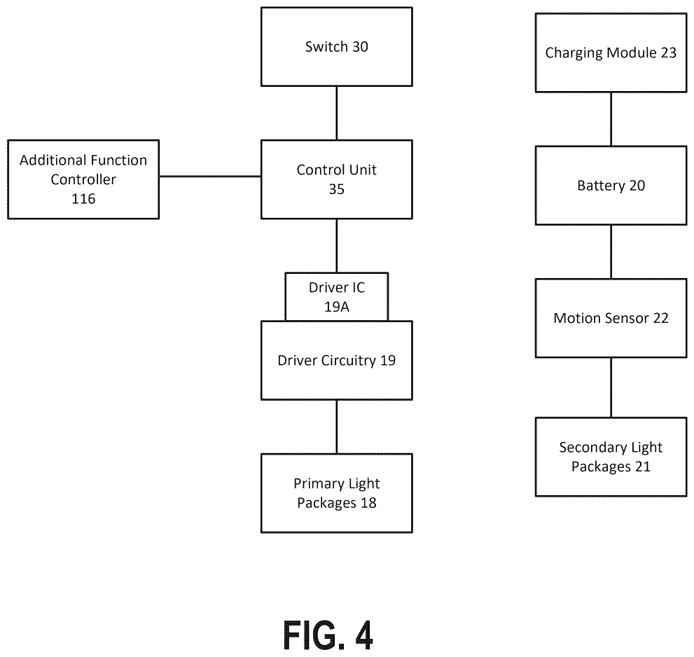

FIG. 4 provides a block wiring diagram of an example lighting device 100. The lighting device 100 may be, for example, a ceiling fan, a desk light, and/or the like. The electrical components of the lighting device 100 may comprise a switch 30 in electrical communication with a control unit 35. The control unit 35 may be in electrical communication with the driver circuitry 19. In an example embodiment, the control unit 35 may be in electrical communication with a driver integrated circuit (IC) 19a configured to control, condition, configure and/or the like the electrical current provided to one or more primary light packages 18. The driver circuitry 19 may then provide the configurable electrical current to the one or more primary light packages 18, causing the lighting device 100 to be operated according to the mode selected through the switch 30. The control unit 35 may be in electrical communication with an additional function controller 116 (e.g., fan motor, UV light source, Bluetooth or other wireless communication module configured to operate a speaker, and/or the like). In various embodiments, the control unit 35 is configured to be operated and to operate the additional function controller 116 and/or primary light packages 18 via line voltage.

A charging module 23 may be in electrical communication with a battery 20. The battery 20 may be in electrical communication with secondary light packages 21. For example, the secondary light packages 21 may be configured to be powered via the battery 20 when the lighting device 100 is not in electrical communication with line voltage. The secondary light packages 21 may be in electrical communication with a motion sensor 22. For example, the motion sensor 22 may be configured to trigger operation of the secondary light packages 21 (using electrical power provided by the battery 20) in response to detecting motion.

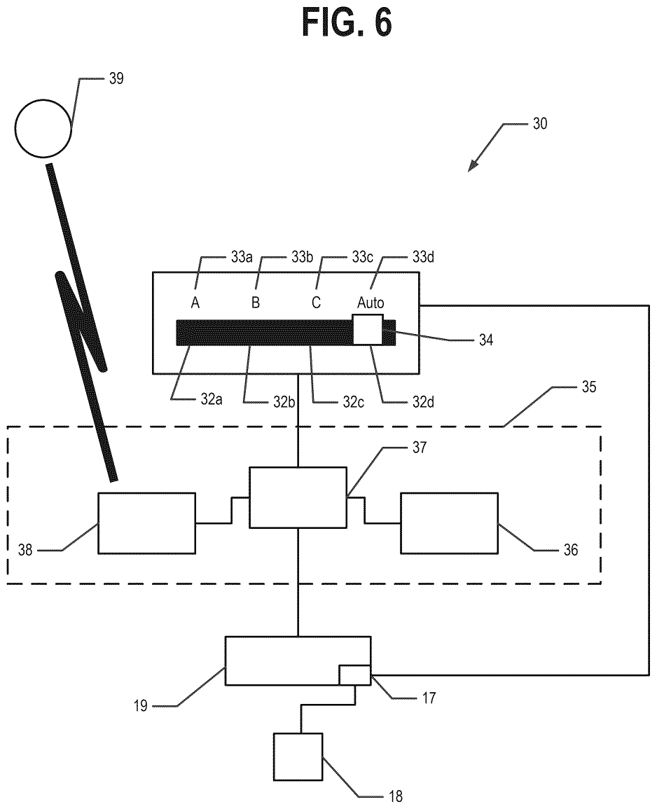

In example embodiments, the one or more lighting devices 100 and/or one or more additional functional components (e.g., UV light) may comprise one or more light packages 18. In an example embodiment, a light package 18 is a light emitting diode (LED) light package. In example embodiments, a light package 18 comprises one or more chips, electrical contacts, and optionally phosphor (e.g., to cause the light package to emit white light). The light package 18 may further comprise encapsulant to protect the one or more chips, wire bonds, and/or the phosphor. In an example embodiment, the light packages 18 may comprise one or more alternate current (AC) driven LEDs. In some embodiments, the light package 18 may further comprise one or more optical elements. In example embodiments, the one or more light packages 18 may comprise two or more light packages 18. In example embodiments, the two or more light packages may comprise at least one first light package 18a and at least one second light package 18b. The first light package 18a may be configured to emit light at a first color temperature and the second light package 18b may be configured to emit light at a second color temperature. The second color temperature may be different from the first color temperature. For example, the first color temperature may be 3000K or 2700K and the second color temperature may be 5000K. In example embodiments, the two or more light packages 18 may further comprise a third and/or fourth light package configured to emit light at a third and/or fourth color temperature, respectively, wherein the third and/or fourth color temperature are different from the first and second color temperatures. For example, in various embodiments, one or more of the light packages 18 may be configured to emit light of at least one of 2700K, 3000K, 3500K, 4000K, 5000K, 5700K, 6000K, 7000K, 7500K and/or other color temperatures, as appropriate for the application. For example, as shown in FIG. 6, the lighting device may be configured to selectively provide light of color temperature A 32a, B 32b, or C 32c, wherein A, B, and C may be any preset color temperature provided each is different relative to one another.

In example embodiments, the two or more light packages 18 may be in electrical communication with driver circuitry 19 such that the two or more light packages 18 may be operated by the driver circuitry 19. For example, the driver circuitry 19 may provide a controlled electrical current to at least one of the light packages 18. For example, the driver circuitry 19 may be configured to only operate first light packages 18a to cause the light engine to emit light of the first color temperature. In another example, the driver circuitry 19 may be configured to only operate second light packages 18b to cause the light engine to emit light of the second color temperature. In another example, the driver circuitry 19 may be configured to operate one or more (e.g., half) of the first light packages 18a and one or more (e.g., half) of the second light packages 18b to cause the light engine to emit light of a third color temperature. In example embodiments, the first color temperature, second color temperature, and third color temperature may be different from one another. For example, the first color temperature may be 3000K, the second color temperature may be 5000K, and the third color temperature may be 4000K. In some embodiments, the light engine may comprise light packages 18 configured to emit light at more than two distinct color temperatures (e.g., three, four, or more distinct color temperatures.

In example embodiments, the one or more light packages 18 may be configured to provide light that varies in brightness, color temperature, CRI, and/or the like based on the current provided to the one or more light packages 18 by the driver circuitry 19. For example, the driver circuitry may provide a particular current to a light package 18 to cause the light package 18 to provide light having particular light aspects or qualities.

In example embodiments, the light packages 18 may comprise one or more light packages 18 that are configured to emit light other than “white” light. For example, the light packages 18 may comprise one or more light packages 18 configured to emit a red or amber light that may be operated to increase the CRI of the light emitted by the light engine.

For example, the electrical components of the example vent fan may comprise one or more secondary light packages 21, motion sensors 22, batteries 20, and/or charging modules 23. In an example embodiment, the secondary light package 21 is a light emitting diode (LED) light package. In example embodiments, the secondary light packages 21 comprise one or more chips, electrical contacts, and optionally phosphor (e.g., to cause the light packages to emit white light). The secondary light packages 21 may further comprise encapsulant to protect the one or more chips, wire bonds, and/or the phosphor. In an example embodiment, the secondary light packages 21 may comprise one or more alternate current (AC) driven LEDs. In some embodiments, the secondary light packages 21 may further comprise one or more optical elements. In example embodiments, the secondary light packages 21 may comprise two or more secondary light packages. In example embodiments, the two or more secondary light packages may comprise at least one first secondary light package 21a and at least one second secondary light package 21b. The first secondary light package 21a may be configured to emit light at a first color temperature and the second secondary light package 21b may be configured to emit light at a second color temperature. The second color temperature may be different from the first color temperature. For example, the first color temperature may be 3000K or 2700K and the second color temperature may be 5000K. In example embodiments, the two or more secondary light packages may further comprise a third and/or fourth light package configured to emit light at a third and/or fourth color temperature, respectively, wherein the third and/or fourth color temperature are different from the first and second color temperatures. For example, in various embodiments, one or more of the secondary light packages 21 may be configured to emit light of at least one of 2700K, 3000K, 3500K, 4000K, 5000K, 5700K, 6000K, 7000K, 7500K and/or other color temperatures, as appropriate for the application. For example, as shown in FIG. 6, the lighting device 100 may be configured to selectively provide light of color temperature A 32a, B 32b, or C 32c, wherein A, B, and C may be any preset color temperature provided each is different relative to one another.

The motion sensor 22 may be a microwave motion sensor module configured to detect motion with a region (e.g., a predetermined region, a room, a region within a circle of a certain radius, etc.). While a microwave control unit may be used as the motion detector of the illustrated embodiments, various types of motion sensors may be used in various embodiments, as appropriate for the application.

The battery 20 may be configured to provide power to the secondary light packages 21 and/or the motion sensor 22. For example, when the lighting device 100 is not in communication with line voltage (e.g., the switch configured to control supply of line voltage to the vent fan is in the OFF position), the motion sensor 22 is powered by the battery 20 to detect motion within a region. When the motion sensor 22 detects motion, the motion sensor 22 causes the secondary light packages 21 to be powered (e.g., by electric power stored in the battery 20).

In an example embodiment, the battery 20 is a rechargeable battery. The charging module 23 is configured to recharge the battery 20. In an example embodiment, the charging module 23 is configured to recharge the battery 20 during a time when the light packages 18 are turned on (e.g., set to an ON state). The secondary light packages 21 may be configured to turn on during a time when the light packages 18 are turned off (e.g., set to an OFF state), for example, based on motion detected by the motion sensor 22. In an example embodiment, the secondary light packages 21 may be configured to turn off after a predetermined time period has elapsed. In an example embodiment, the secondary light packages 21 may function as night light(s). For example, motion may be detected within a region may trigger the secondary light packages 21 to be turned on. In this example, the secondary light packages 21 may remain on until, for example, 60 seconds pass, at which point the secondary light packages 21 may turn off.

### Example Driver Circuitry

In example embodiments, the driver circuitry 19 may be configured to provide a controlled electrical current to at least one of the light packages 18 during operation of at least one light engine of the lighting device. In various embodiments, the driver circuitry 19 may comprise a circuit portion configured to convert AC voltage into DC voltage. In some embodiments, the driver circuitry 19 may comprise a circuit portion configured to control the current flowing through the two or more light packages 18. In certain embodiments, the driver circuitry 19 may comprise a circuit portion configured to dim the one or more light engines of the lighting device. In various embodiments, additional circuit components may be present in the driver circuitry 19. Similarly, in various embodiments, all or some of the circuit portions mentioned here may not be present in the driver circuitry 19. In some embodiments, circuit portions listed herein as separate circuit portions may be combined into one circuit portion. As should be appreciated, a variety of driver circuitry configurations are generally known and understood in the art and any of such may be employed in various embodiments as suitable for the intended application, without departing from the scope of the present disclosure.

In example embodiments, the driver circuitry 19 may be configured to operate subsets of the two or more light packages 18 at a particular given moment in time. For example, if a first color temperature has been selected by a user as the operating color temperature, the driver circuitry 19 may be configured to operate one or more first light packages 18a configured to emit light at the selected first color temperature. If a second color temperature has been selected by the user as the operating color temperature, the driver circuitry 19 may be configured to operate one or more second light packages 18b configured to emit light at the second selected color temperature. If a third color temperature has been selected by the user as the operating color temperature, the driver circuitry 19 may be configured to operate at least a portion of the first light packages 18a (e.g., half of the first light packages 18a) and at least a portion of the second light packages 18b (e.g., half of the second light packages 18b) to provide (e.g., via a combination of the first and second light packages) a selected third color temperature that is a composite, mixture, or superposition of the first and second color temperatures. The selection of which light packages 18 are operated by the driver circuitry 19, when the lighting device 100 is operated, is determined by the status of the switch 30 and/or by the control unit 35. For example, the driver circuitry 19 may comprise a plurality of provider circuits 17 configured to provide a controlled electrical current to a subset of the two or more light packages 18 depending on the selected operating color temperature and/or the status of the switch 30.

In another example, the driver circuitry 19 may be configured to provide a particular current to one or more of the light packages 18 to provide light having specific light aspects qualities (e.g., brightness, color temperature, CRI, and/or the like). For example, the driver circuitry 19 may be configured to drive one or more light packages 18 such that the light packages provide light having the desired light aspects or qualities. The determination of how one or more of the light packages 18 should be driven (e.g., what current should be supplied to the light packages 18) may be determined by the status of the switch 30 and/or by the control unit 35. Based on the desired light aspects or qualities, different light packages 18 may be driven differently. For example, light packages 18 may be driven differently from a red or amber light package 18 that is being operated to increase the CRI of the light emitted by the one or more light engines of the lighting device. Thus, the provider circuits 17 may be configured to provide various light packages 18 with a particular configurable current such that the composite light emitted by the one or more light engines of the lighting device has the user desired light aspects or qualities.

In example embodiments, various configurations of provider circuits 17 may be applied. For example, as noted above, a provider circuit 17 may be configured to provide electrical current to only the first light packages 18a, only the second light packages 18b, or a predetermined combination of the first and second light packages 18a and 18b. For example, a provider circuit 17 may be configured to provide electrical current to half of the first light packages 18a and half of the second light packages 18b to provide light of the third color temperature. In another example, a provider circuit 17 may be configured to provide electrical current to 25% of the first light packages 18a and 75% of the second light packages 18b to provide light of a fourth color temperature. It should be understood that a provider circuit 17 may be configured to provide controlled electrical current to various combinations of the first light packages 18a and the second light packages 18b to provide various color temperature options. Furthermore, in example embodiments, the two or more light packages 18 may comprise three or more light packages 18. For example, the light packages 18 may comprise at least one first light package 18a configured to emit light at a first color temperature, at least one second light package 18b configured to emit light at a second color temperature, and at least one third light package configured to emit light at a third color temperature, the first, second, and third color temperatures being different from one another. In such an embodiment, a provider circuit 17 may be configured to provide electrical current to at least one of the first light packages 18a, at least one of the second light packages 18b, and at least one of the third light packages to provide a three color blend. It should be understood that light packages configured to emit light at additional color temperatures may be incorporated into the lighting device 100 as desired and/or appropriate for the application and that various combinations of the light packages may be activated to cause the lighting device 100 to emit light of a desired operating color temperature.

As noted above, the light aspects or qualities (e.g., brightness, color temperature, CRI, and/or the like) may be controlled by how the one or more light packages 18 are operated (instead of and/or in addition to which of the light packages 18 are operated). In example embodiments, one or more configurable qualities of the light emitted by the lighting device 100 may configured by controlling the current provided to one or more of the light packages 18. In particular, the driver circuitry 19 may drive the one or more light packages 18 with a higher or lower current to modify the brightness, color temperature, CRI, and/or the like of the light emitted by the one or more light packages 18. In another example, the driver circuitry 19 may increase or decrease the number of light packages 18 being driven to increase or decrease the brightness of the light emitted by the lighting device 100. In another example, one or more red or amber light packages 18 may be turned on (e.g., electrical current may be supplied thereto by the driver circuitry 19) to increase the CRI of the light emitted by the lighting device 100. In another example, the primary or secondary optics used to condition the light emitted by the lighting device 100. For example, the optics 13 may be modified, the amount of phosphor through which a lighting is emitting may be modified, and/or the like. Thus, in example embodiments, one or more qualities of the light emitted by the lighting device 100 may be modified, controlled, configured, and/or the like by changing and/or controlling the amount of current provided to one or more light packages 18, which light packages 18 of the two or more light packages 18 are being operated, physically changing the primary and/or secondary optics conditioning the light, and/or the like. Thus, for example in an embodiment configured to provide configurable brightness settings or modes, the dimming of the lighting device 100 may be controlled by the control unit 35 and/or driver circuitry 19 rather than by the externally provided current.

In example embodiments, when the lighting device 100 is in a configurable operating mode, interaction with the remote switch 40 (e.g., reception of a signal from the remote switch 40) may cause the topology of the driver circuitry to be altered. For example, user interaction with the remote switch 40 may cause a signal to be provided to the control unit 35. The control unit 35 may then cause a change in the topology of the driver circuitry 19, thereby causing the driver circuitry 19 to operate a different set of light packages 18, drive one or more light packages 18 with a modified current, and/or the like.

### Example Operation of a Lighting Device

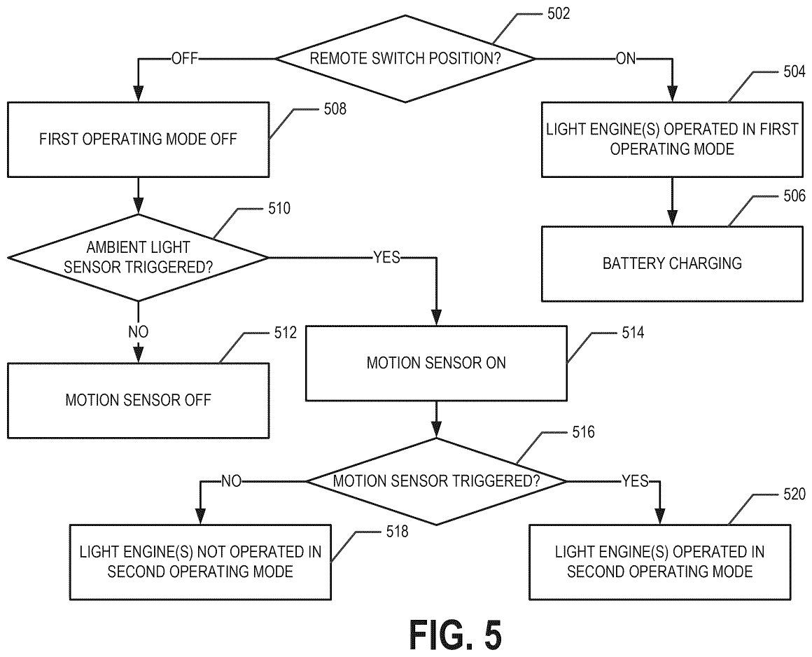

FIG. 5 provides a flowchart that illustrates the operation of an example lighting device 100 that is in communication with a remote switch 40. In various embodiments, the remote switch 40 is configured to be in an on position or an off position. For example, in certain embodiments, the remote switch 40 is a toggle switch, a wall switch, and on/off switch, and/or the like. Starting at 502, control of whether the light engines 114 are operated in the first operating mode. Responsive to the remote switch 40 being in the on position (e.g., possibly causing line electrical power to be provided to the lighting device 100) the light engine(s) 114 are operated in the first operating mode at 504. In various embodiments, responsive to the remote switch 40 being in the on position (e.g., possibly causing line electrical power to be provided to the lighting device 100) the charging module 224 causes charging of the battery 222. In various embodiments, the operation of the light engine(s) 114 in the first operating mode is a direct consequence of whether or not line electrical power is provided to the lighting device 100 (e.g., as a result of the position of the remote switch 40). In certain embodiments, the operation of the light engine(s) 114 in the first operating mode is controlled by the control unit 118. For example, in some embodiments, the control unit 118 may determine a position of the remote switch 40 and/or whether line electrical power is being provided to the lighting device 100 and, based on a result of the determine, cause the light engine(s) 114 to be operated in the first operating mode or not.

Responsive to the remote switch 40 being in the off position (e.g., possibly preventing line electrical power from being provided to the lighting device 100), the light engine(s) 114 are not operated in the first operating mode, at 508. In certain embodiments, at 510, whether the ambient light sensor (e.g., photosensor 128) is triggered controls whether the motion sensor 120 is activated. Responsive to the ambient light sensor not being triggered (e.g., the photosensor 128 of the ambient light sensor detects ambient light that is brighter than a threshold brightness), the motion sensor is off and/or not activated at 512. Responsive to the ambient light sensor being triggered (e.g., the photosensor 128 of the ambient light sensor detects ambient light that is not brighter than a threshold brightness), the motion sensor is on and/or activated at 514. For example, in certain embodiments, the control unit 118 may monitor the brightness of ambient light detected by the photosensor 128 and control whether the motion sensor is on or activated. In another example, the current generated by the detection of ambient light by the photosensor 128 may control whether or not the motion sensor is on or activated. For example, an FPGA or transistor switch may be configured to cause the motion sensor to be turned on or activated when the current generated by the photosensor 128 responsive to the detected ambient light falls below a threshold current (and to cause the motion sensor to be turned off or deactivated when the current generated by the photosensor 128 responsive to the detected ambient light rises above the threshold current).

Responsive to the motion sensor 120 not being triggered, the light engine(s) 114 are not operated in the second operating mode, at 518. For example, the light engine(s) 114 may not be operated such that the lighting device 100 is not emitting light. Responsive to the motion sensor 120 being triggered, the light engine(s) 114 are operated in the second operating mode, at 520. In various embodiments, the light engine(s) 114 are powered by the battery 222 when operating in the second operating mode. For example, a control unit 118, the microwave control unit 220, an FPGA, transistor switch, and/or the like may be configured to cause the lighting engine(s) 114 to be operated in a second operating mode responsive to the motion sensor 120 to be triggered. In some embodiments, the control unit 118, microwave control unit 220, FPGA, transistor switch, and/or the like may be configured to cause the lighting engine(s) 114 to cease being operated in a second operating mode responsive to a set and/or configurable amount of time passing after the motion sensor 120 was last triggered.

### Example Switch

In example embodiments, the lighting device 100 comprises a switch 30 (e.g., 124 depicted on FIG. 1B). In example embodiments, the switch 30 may be configured to allow a user to select an operating mode (e.g., a programmable custom mode, a set mode, or a configurable mode). In various embodiments, the switch may allow a user to control the power distributed to one or more light engines 114 and/or at least one additional functional component (e.g., fan motor, UV light, ceiling vent fan, etc.), wherein the power selection may then be controlled based on the user-selected operating mode. In some embodiments, the switch may be further configured to allow a user to adjust one or more aspects or qualities of the light (e.g., color temperature, brightness, CRI, and/or the like) emitted by the lighting device 100, one or more light engines 114, and/or one or more UV lights 122, wherein the aspects or qualities may then be controlled based on the user-selected operating mode. In example embodiments, the switch 30 may be a mechanical switch, electro-mechanical switch, an infrared switch, and/or the like. For example, if the switch 30 is a mechanical switch, the switch 30 may comprise a slide switch, a dial, a set of binary switches, and/or the like. In an example embodiments, the switch 30, and/or a user interface thereof, may be disposed on an exterior surface of the housing 110. FIG. 6 provides a block diagram of at least some of the electrical components of a lighting device 100, one or more light engines 114 and/or one or more additional functional components, including a switch 30 and a control unit 35, in accordance with example embodiments of the present disclosure. In example embodiments, the switch 30 may comprise a plurality of switch positions 32 (e.g., 32a, 32b, 32c, 32d), switch position indicators 33 (e.g., 33a, 33b, 33c, 33d), and a switch selector 34. For example, the switch 30 may comprise four switch positions 32a, 32b, 32c, and 32d, in example embodiments. In other embodiments, the switch 30 may comprise more than four switch positions 32 (e.g., 32a, 32b, 32c, 32d). For example, in various embodiments, the switch 30 may comprise two, three, four, five, six, seven, eight, or more switch positions with each switch position corresponding to either a set operating mode, a selectively configurable operating mode, or a programmable custom operating mode. One of the switch positions may correspond to a configurable operating mode (e.g., a configurable power selection mode, a configurable operating color temperature mode, configurable brightness mode, configurable brightness-color temperature mode, etc.) and the remaining switch positions may correspond to set operating modes (e.g., set power selection mode, set operating color temperature modes, set brightness modes, set operating brightness-color temperature modes, etc.).

In some embodiments, the switch 30 may provide the user with one or more programmable custom operating modes. In an example embodiment, the switch 30 may comprise a custom set operating the power selection for the one or more light engines and/or at least one additional functional component such that the one or more light engines and/or the at least one additional functional components cycle through a plurality of power modes. In another example, the switch 30 may comprise a custom program operating mode wherein the control unit 35 is configured to cause the operating color temperature, brightness, and/or CRI to change at configurable times (e.g., clock time) or at configurable periods of time.

In another example, a user may want the one or more light engines 114 and/or at least one additional functional component (e.g., fan motor, speaker, UV light, etc.) to operate for a predetermined amount of time and then to turn off power to the one or more light engines and/or at least one additional functional component (e.g., fan motor, speaker, UV light, etc.) after the predetermined amount of time has elapsed. In example embodiments having programmable custom operating mode options, additional user interface components (e.g., in addition to the switch 30) may be provided for the programming of the programmable custom operating mode. The additional user interface components may be located on the housing 110 of the lighting device and/or on a remote switch 40 (e.g., through a mobile computing entity 70 user interface, wherein the computing entity 70 is executing an application causing the computing entity 70 to operate as a remote switch 40). In example embodiments, such additional user interface components may comprise various switches, dials, displays, touchscreen displays, buttons, knobs, and/or the like as commonly understood in the art.

A switch position indicator 33 (e.g., 33a, 33b, 33c, 33d) may correspond to each switch position 32 (e.g., 32a, 32b, 32c, 32d). The switch position indicator 33 (e.g., 33a, 33b, 33c, 33d) may be configured to indicate the power selection for the light engines 114 and/or at least one additional functional component. In an example embodiment, a user-selection switch 30 (e.g., a toggle switch, button, and/or the like, 124 depicted in FIG. 1B) may be disposed on the lighting device 100 such that user-selection may be received through user-selection switch at the lighting device 100.

### Example Control Unit

In example embodiments, the lighting device 100 may comprise a control unit 35. In example embodiments, the control unit 35 may be configured to cause the driver circuitry 19 to operate one or more light packages 18 of the light engines and/or at least one additional functional component in accordance with the user-selected operating mode (e.g., a programmable custom mode, a set mode, or a configurable mode). In example embodiments, the control unit 35 may be configured to charge a battery (e.g., a rechargeable battery configured to provide power to at least one secondary light engine) while the control unit 35 is in an ON state (e.g., and while at least one primary light engine is in an ON state). In these example embodiments, the at least one secondary light engine may use the battery as a power source (e.g., and turn ON based on a motion sensor detecting motion within a predetermined region) based on the control unit 35 (e.g., and/or the at least one primary light engine)n being in an OFF state.

In example embodiments, the control unit 35 may be a microcontroller unit (M CU). For example, the control unit 35 may comprise a single integrated circuit. In example embodiments, the control unit 35 comprises one or more processing elements 37, one or more memory elements 36, and/or one or more communications interface elements 38. In example embodiments, the control unit 35 may be in wired (e.g., hard-wired) communication with the switch 30 and/or configured to receive signals from the remote switch 40. In example embodiments, the control unit 35 may be configured to cause power selection of one or more light engines and/or at least one additional functional component of the lighting device 100 to be modified based on a received signal from the remote switch 40, store information/data identifying the last power selection at which the light engine or the lighting device 100 was operated at, and/or the like. For example, the control unit 35 may be configured to receive user selection of a programmable custom operating mode and control the light engine 114 and/or at least one additional functional component of the lighting device 100 to operate in accordance with the programmable custom operating mode or other user-selected operating mode (e.g., set operating mode or configurable operating mode).

In example embodiments, the one or more processing elements 37 (also referred to as processors, processing circuitry, processing device, and/or similar terms used herein interchangeably) that communicate with other elements within the control unit 35. For example, the processing element(s) 37 may communicate with the memory element(s) 36, communication interface element(s) 38, and/or components of the driver circuitry 19 via direct electrical connection, a bus, and/or the like. For example, the processing element(s) 37 may be configured to process input received through the switch 30 (and/or additional user interface components), process a signal received from the remote switch 40 (e.g., through the communications interface element 38), cause the memory element 36 to store a current power selection, cause one provider circuit 17 to be activated (e.g., to provide a controlled electric current to the corresponding at least one light package 18 and/or at least one additional functional component), cause another provider circuit 17 to be de-activated (e.g., to stop providing an electric current to the corresponding at least one light package 18 of the light engines and/or at least one additional functional component), cause a different and/or modified current to be provided to the provider circuit 17 and/or the like. As will be understood, the processing element 37 may be embodied in a number of different ways. For example, the processing element 37 may be embodied as one or more complex programmable logic devices (CPLDs), microprocessors, multi-core processors, co-processing entities, application-specific instruction-set processors (ASIPs), microcontrollers, and/or controllers. Further, the processing element 37 may be embodied as one or more other processing devices or circuitry. The term circuitry may refer to an entirely hardware embodiment or a combination of hardware and computer program products. Thus, the processing element 37 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 37 may be configured for a particular use or configured to execute instructions stored in volatile or non-volatile media or otherwise accessible to the processing element 37. As such, whether configured by hardware or computer program products, or by a combination thereof, the processing element 37 may be capable of performing steps or operations according to embodiments of the present disclosure when configured accordingly.

The memory element(s) 36 may be non-transitory and may include, for example, one or more volatile and/or non-volatile memories. In other words, for example, the memory element 36 may be an electronic storage device (e.g., a computer readable storage medium) comprising gates configured to store data (e.g., bits) that may be retrievable by a machine (e.g., a computing device like the processing element 37). The memory element 36 may be configured to store information, data, content, applications, instructions, or the like for enabling the control unit 35 to carry out various functions in accordance with an example embodiment of the present disclosure. For example, the memory element 36 could be configured to buffer input data for processing by the processing element 37 (e.g., a signal received from the remote switch 40). Additionally or alternatively, the memory element 36 could be configured to store instructions for execution by the processing element 37.

As indicated, in one embodiment, the control unit 35 may also include one or more communications interface elements 38 for communicating with the remote switch 40. For example, the communications interface element 38 may be configured to receive a signal from the remote switch 40 indicating user selection of, activation of, and/or interaction with an on/off or power button, a dimmer switch, or a remote selector switch configured to select or modify the current distributed to one or more light engines 114 and/or at least one additional functional component of the lighting device 100, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the communications interface element 38 may be configured to communicate via a wireless communication technology, such as a short-range communication technology. For example, the communications interface element 38 may be configured to receive and/or send signals using IEEE 802.11 (Wi-Fi), Wi-Fi Direct, 802.16 (WIMAX), ultra-wideband (UWB), infrared (IR) protocols, near field communication (NFC) protocols, Wibree, Bluetooth protocols, wireless universal serial bus (USB) protocols, and/or any other wireless protocol.

In example embodiments, the control unit 35 may be configured to control the current selection (e.g., turn on or turn off) the one or more light engines 114 and/or at least one additional functional components (e.g., UV light, ceiling fan, fan motor, vent fan, etc.) of the lighting device 100. For example, the control unit 35 may be configured to determine the current power selection for the one or more light engines 114 and/or at least one additional functional components accordingly. For example, the control unit 35 may be configured to determine if the position of the switch selector 34 is a position corresponding to a set operating mode, to the position corresponding to the configurable operating mode, and/or to a position corresponding to a programmable custom operating mode. If the switch selector 34 is in a switch position 32 (e.g., 32a, 32b, 32c) corresponding to a set operating mode, the control unit 35 (e.g., the processing element 37) may determine the power cycle for the one or more light engines and/or at least one additional functional component (e.g., first cycle power on for both light engines and a first additional functional component, a second cycle power on for the one or more light engines and power off for the first additional functional component, and/or a third cycle power off for the one or more light engines and power on for the first additional functional component).

In various embodiments, the control unit 35 is in communication with one or more sensors 39. For example, the control unit 35 may communicate with one or more sensors via the communications interface element 38. In an example embodiment, the control unit 35 communicates with the one or more sensors wirelessly. In an example embodiment, the control unit 35 is in wired communication with the one or more sensors. In an example embodiment, the light engine 114 and/or at least one additional functional component of the lighting device 100 may comprise one or more sensors 39. In various embodiments, the one or more sensors 39 may comprise light sensors, photocells, motion sensors, noise sensors, and/or the like. In an example embodiment, the processing element 37 is configured to receive signals from one or more sensors 39 (e.g., via the communications interface element 38) and causes the operation of the light engine 114 and/or at least one additional functional component (e.g., fan, UV light, etc.) of the lighting device 100 to be adjusted, modified, or the like based on the received signals (e.g., turn power on or turn power off for the light engines and/or at least one additional functional components). In an example embodiment, the processing element 37 only adjusts, modifies, or the like the operation of the light engine 114 and/or at least one additional functional component (e.g., fan, UV light, etc.) of the lighting device 100 based on signals received from one or more sensors 39 when the status of the switch 30 corresponds to a configurable operating mode. In an example embodiment, the processing element 37 adjusts, modifies, or the like the current distributed to the light engines 114 and/or at least one additional functional component (e.g., fan, UV light, etc.) of the lighting device 100 based signals received from the one or more sensors 39 when the status of the switch 30 corresponds to a set operating mode such that the power current to the one or more light engines 114 and/or the at least one additional functional component (e.g., UV light, ceiling fan, vent fan etc.) is configured to be powered off in response to one or more signals received from the sensor.

### Example Remote Switch

Example embodiments of the present disclosure comprise a remote switch 40. In example embodiments, a remote switch 40 may be a wall mounted switch mounted in the same room as the light engine 114 and/or at least one additional functional component (e.g., fan, UV light, etc.) of the lighting device 100 and/or within a short-range communication technology range of the light engine 114 and/or at least one additional functional component (e.g., fan, UV light, etc.) of the lighting device 100. For example, the remote switch 40 may be a wall and/or junction box mounted toggle switch, dimmer switch and/or the like in wired communication with the control unit 35. In another example, the remote switch 40 may be a handheld device (e.g., a remote control, or computing entity 70) that is within the same room as the light engine 114 and/or at least one additional functional component (e.g., fan, UV light, etc.) of the lighting device 100, within a short-range communication technology range of the light engine 114 and/or at least one additional functional component (e.g., fan, UV light, etc.) of the lighting device 100, in communication with the control unit 35 through a wireless network, and/or the like. In example embodiments, the remote switch 40 may be in wired or wireless communication with the control unit 35. For example, the remote switch 40 may be configured to control the power selection of the light engine 114 and/or at least one additional functional component (e.g., fan, UV light, etc.) of the lighting device 100 or aspects thereof by providing a signal to the control unit 35 indicating user selection, interaction, and/or the like with one or more interactive elements of the remote switch 40. For example, the remote switch 40 may be configured to allow a user to toggle through one or more power selection of the one or more light engine 114 and/or at least one additional functional component (e.g., fan, UV light, etc.) of the lighting device 100. In example embodiments, the toggling of the remote switch 40 to change or modify the power selection could be at any time interval from 1 ms to 1 min. In some embodiments, the remote switch 40 may be configured to complete a plurality of toggles to adjust/change the power light engine 114 and/or at least one additional functional component (e.g., fan, UV light, etc.) of the lighting device 100, wherein the toggles must be completed before the elapsing of a predetermined amount of time resets the toggles.

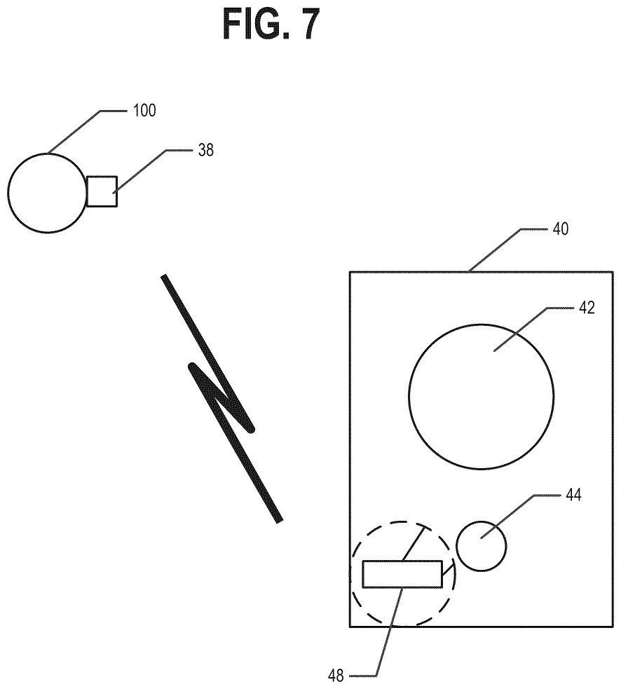

For example, the remote switch 40 may be configured to cause the light engine 114 and/or at least one additional functional component (e.g., fan, UV light, etc.) of the lighting device 100 to turn on or off, control the brightness of the lighting device 100 (e.g., through a dimmer switch), change the operating light aspects or qualities of the lighting device 100, program a programmable custom operating mode, and/or the like. An example remote switch 40 is illustrated in FIG. 7. In example embodiments, the remote switch 40 comprises one or more interactive elements (e.g., 42, 44). For example, the remote switch 40 includes an interactive element 42 that is an on/off and/or dimmer switch configured to turn on/off light engine 114 and/or at least one additional functional component (e.g., fan, etc.) of the lighting device 100. The remote switch 40 may comprise a remote selector 44 (e.g., a color temperature control) configured for remotely selecting an operating color temperature of the lighting device 100 when the lighting device 100 is in the configurable operating mode. In example embodiments, the remote selector 44 may be a slide, push button, rotary, passive infrared and/or other type of interactive element that the user may interact with, select, press, touch, voice activate, and/or the like. Thus, the remote selector 44 may be configured to allow a user to select a desired operating color temperature, brightness, CRI, and/or other operating aspects or qualities, of the light engine 114 and/or at least one additional functional component (e.g., fan, etc.) of the lighting device 100. In example embodiments, the remote switch 40 may comprise additional user interface components as appropriate for the application.

The remote switch 40 may further comprise a communication interface 48. In example embodiments, the communication interface 48 may be a part of a control unit that is similar to the control unit 35 (e.g., the control unit may comprise a processing element and/or memory element in addition to the communication interface 48). In example embodiments, the communication interface 48 is configured to provide a signal to the communications interface element 38 indicating user selection and/or interaction with the interactive element 42 (e.g., an on/off and/or dimmer switch), the remote selector 44, and/or the like.

For example, the communication interface 48 may be configured to communicate with the control unit 35. For example, the communication interface 48 may be configured to provide a signal to the communications interface element 38 indicating user selection of, activation of, and/or interaction with an interactive element 42 (e.g., an on/off and/or dimmer switch), remote selector 44, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the communication interface 48 may be configured to communicate via a wireless communication technology, such as a short-range communication technology. For example, the communication interface 48 may be configured to receive and/or send signals using IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

### Example Computing Device Used as a Remote Switch

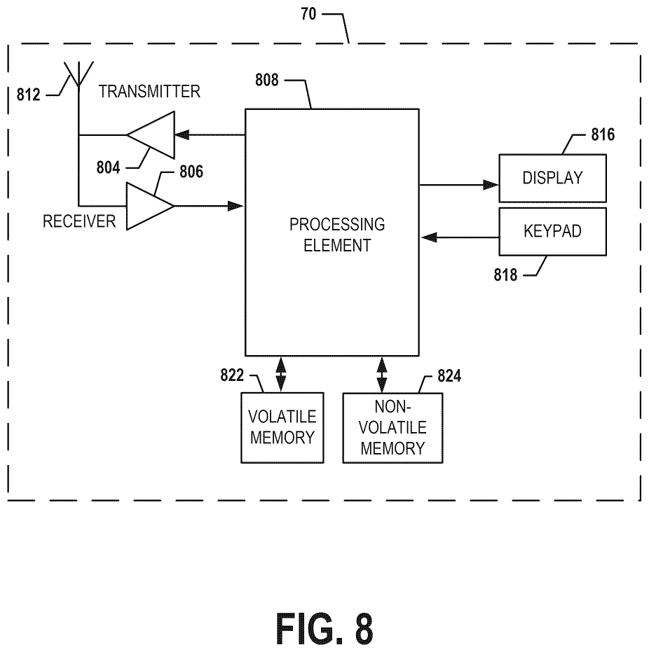

FIG. 8 provides an illustrative schematic representative of a computing entity 70 that can be used in conjunction with embodiments of the present disclosure. In particular, the computing entity 70 may be configured to operate and/or execute an application configured to cause the computing entity 70 to act as a remote switch 60. For example, the computing entity 70 may operate and/or execute an application configured to communicate with the control unit 35 and/or cause one or more aspects (e.g., current distributed to the one or more light engines and/or at least one additional functional components, brightness of one or more light engines and/or UV light, color of one or more light engine, etc.) to change for the light engine 114 and/or at least one additional functional component (e.g., fan, etc.) of the lighting device 100. In example embodiments, the computing entity 70 may be a mobile computing entity such as a mobile phone, tablet, phablet, wearable computing device, personal digital assistant (PDA) , MP3 player, and/or the like. In an example embodiment, the remote switch 60 may be a building control system (e.g., a digital addressable lighting interface (DALI)-based building control system).

As shown in FIG. 8, a computing entity 70 can include an antenna 812, a transmitter 804 (e.g., radio), a receiver 806 (e.g., radio), and a processing element 808 that provides signals to and receives signals from the transmitter 804 and receiver 806, respectively. The signals provided to and received from the transmitter 804 and the receiver 806, respectively, may include signaling information/data in accordance with an air interface standard of applicable wireless systems to communicate with various entities, such as control unit 35, another computing entity 70, and/or the like. In this regard, the computing entity 70 may be capable of operating with one or more air interface standards, communication protocols, modulation types, and access types. More particularly, the computing entity 70 may operate in accordance with any of a number of wireless communication standards and protocols. In a particular embodiment, the computing entity 50 may operate in accordance with multiple wireless communication standards and protocols, such as GPRS, UMTS, CDMA 2000, 1xRTT, WCDMA, TD-SCDMA, LTE, E-UTRAN, EVDO, HSPA, HSDPA, Wi-Fi, WIMAX, UWB, IR protocols, Bluetooth protocols, USB protocols, and/or any other wireless protocol.

Via these communication standards and protocols, the computing entity 70 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 70 can also download changes, add-ons, and updates, for instance, to its firmware, software (e.g., including executable instructions, applications, program modules), and operating system.

According to one embodiment, the computing entity 50 may include location determining aspects, devices, modules, functionalities, and/or similar words used herein interchangeably. For example, the computing entity 70 may include outdoor positioning aspects, such as a location module adapted to acquire, for example, latitude, longitude, altitude, geocode, course, direction, heading, speed, UTC, date, and/or various other information/data. In one embodiment, the location module can acquire data, sometimes known as ephemeris data, by identifying the number of satellites in view and the relative positions of those satellites. The satellites may be a variety of different satellites, including LEO satellite systems, DOD satellite systems, the European Union Galileo positioning systems, the Chinese Compass navigation systems, Indian Regional Navigational satellite systems, and/or the like. Alternatively, the location information/data may be determined by triangulating the computing entity's 70 position in connection with a variety of other systems, including cellular towers, Wi-Fi access points, and/or the like. Similarly, the computing entity 70 may include indoor positioning aspects, such as a location module adapted to acquire, for example, latitude, longitude, altitude, geocode, course, direction, heading, speed, time, date, and/or various other information/data. Some of the indoor aspects may use various position or location technologies including RFID tags, indoor beacons or transmitters, Wi-Fi access points, cellular towers, nearby computing devices (e.g., smartphones, laptops) and/or the like. For instance, such technologies may include iBeacons, Gimbal proximity beacons, BLE transmitters, Near Field Communication (NFC) transmitters, and/or the like. These indoor positioning aspects can be used in a variety of settings to determine the location of someone or something to within inches or centimeters.

The computing entity 70 may also comprise a user interface (that can include a display 816 coupled to a processing element 808) and/or a user input interface (coupled to a processing element 808). For example, the user interface may be an application, browser, user interface, dashboard, webpage, and/or similar words used herein interchangeably executing on and/or accessible via the computing entity 70 to interact with and/or cause display of information. The user input interface can comprise any of a number of devices allowing the computing entity 70 to receive data, such as a keypad 818 (hard or soft), a touch display, voice/speech or motion interfaces, scanners, readers, or other input device. In embodiments including a keypad 818, the keypad 818 can include (or cause display of) the conventional numeric (0-9) and related keys (#, *), and other keys used for operating the computing entity 70 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 70 can collect contextual information/data as part of the telematics data.

The computing entity 70 can also include volatile storage or memory 822 and/or non-volatile storage or memory 824, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 70.

### CONCLUSION

Many modifications and other embodiments of the disclosure set forth herein will come to mind to one skilled in the art to which the disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A lighting device comprising:
one or more light engines configured to provide light in a first operating mode and a second operating mode, wherein the one or more light engines emit light of higher luminosity when operating in the first operating mode than when operating in the second operating mode;
at least one rechargeable battery configured to provide power to at least one of the one or more light engines when the one or more light engines are providing light in the second operating mode;
at least one motion sensor;
at least one ambient light sensor;
a shield configured to control a field of view of the at least one motion sensor; and
a control unit configured to operate the one or more light engines, the at least one rechargeable battery, the at least one ambient light sensor, and the at least one motion sensor, the control unit in communication with the one or more light engines, the at least one rechargeable battery, and the at least one motion sensor, wherein the control unit is configured to operate the one or more light engines in the second operating mode using power from the at least one rechargeable battery responsive to the at least one motion sensor detecting motion,
wherein the shield is configured to block up to 2π steradians of the field of view of the at least one motion sensor,
wherein the lighting device is configured to selectively be coupled to line voltage via a remote switch, when the lighting device is coupled to the line voltage, the control unit is configured to cause the one or more light engines to be operated in the first operating mode and to cause the rechargeable battery to be recharged and when the lighting device is not coupled to the line voltage, the control unit is configured to activate the at least one motion sensor responsive to the at least one ambient light sensor being triggered.

2. The lighting device of claim 1, further comprising a physical switch thereon configured to control a detection distance of the at least one motion sensor.

3. The lighting device of claim 1, wherein the at least one rechargeable battery is a rechargeable battery configured to recharge while the one or more light engines are being operated in the first operating mode and the motion sensor is only operated when the lighting device is not coupled to the line voltage and the at least one ambient light sensor indicates an ambient light threshold is satisfied.

4. The lighting device of claim 1, wherein the at least one motion sensor is configured to (a) detect motion within a predetermined region, and (b) indicate to the control unit to activate the at least one of the one or more light engines in the second operating mode based on detecting motion within the predetermined region.

5. (canceled)

6. The lighting device of claim 4, wherein the control unit is configured to stop operating the at least one of the one or more light engines in the second operating mode after a predetermined time period has elapsed since operation of the at least one of the one or more light engines in the second operating mode was initiated.

7. (canceled)

8. (canceled)

9. The lighting device of claim 1, further comprising at least one additional functional component, wherein the control unit is configured to, at least in part, control operation of the at least one additional functional component.

10. The lighting device of claim 9, wherein the at least one additional functional component comprises at least one of a vent fan, a fan motor, a UV light source, or a speaker.

11. The lighting device of claim 9, wherein the one or more light engines are operated in the first operating mode using the line voltage and the at least one additional functional component is operated using the line voltage.

12. A vent fan system comprising:
a vent fan;
a lighting device, the lighting device comprising:
one or more light engines configured to provide light in a first operating mode and a second operating mode, wherein the one or more light engines emit light of higher luminosity when operating in the first operating mode than when operating in the second operating mode;
at least one rechargeable battery configured to provide power to at least one of the one or more light engines when the one or more light engines are providing light in the second operating mode;
at least one ambient light sensor; and
at least one motion sensor;
a shield configured to control a field of view of the at least one motion sensor; and
a control unit configured to operate the one or more light engines and the vent fan, the at least one rechargeable battery, and the at least one motion sensor, the control unit in communication with the one or more light engines, the at least one rechargeable battery, and the at least one motion sensor, wherein the control unit is configured to operate the at least one of the one or more light engines in the second operating mode using power from the at least one rechargeable battery responsive to the at least one motion sensor detecting motion,
wherein the shield is configured to block up to 2π steradians of the field of view of the at least one motion sensor, and
wherein the lighting device is configured to selectively be coupled to line voltage via a remote switch, when the lighting device is coupled to the line voltage, the control unit is configured to cause the one or more light engines to be operated in the first operating mode and to cause the rechargeable battery to be recharged and when the lighting device is not coupled to the line voltage, the control unit is configured to activate the at least one motion sensor responsive to the at least one ambient light sensor being triggered.

13. The vent fan system of claim 12, further comprising a physical switch thereon configured to control a detection distance of the at least one motion sensor.

14. The vent fan system of claim 12, wherein the at least one rechargeable battery is a rechargeable battery configured to recharge while the one or more light engines are being operated in the first operating mode.

15. The vent fan system of claim 12, wherein the at least one motion sensor is configured to (a) detect motion within a predetermined region, and (b) indicate to the control unit to activate the at least one of the one or more light engines in the second operating mode based on detecting motion within the predetermined region.

16. The vent fan system of claim 15, wherein the at least one motion sensor is only activated when the one or more light engines are not being operated in the first operating mode.

17. The vent fan system of claim 15, wherein the control unit is configured to stop operating the at least one of the one or more light engines in the second operating mode after a predetermined time period has elapsed since operation of the at least one of the one or more light engines in the second operating mode was initiated.

18. The lighting device of claim 12, wherein the one or more light engines are operated in the first operating mode using the line voltage and the vent fan is operated using the line voltage.

19. A device comprising:
one or more functional components configured to be operated via application of line voltage to the device;
at least one light engine;
at least one rechargeable battery configured to power the at least one light engine in an auxiliary lighting operating mode;
at least one motion sensor;
a shield configured to control a field of view of the at least one motion sensor;
at least one light sensor; and
a control unit configured to operate the one or more functional components, the at least one light engine, the at least one rechargeable battery, the at least one motion sensor, and the at least one light sensor, wherein the control unit is configured to, responsive to the line voltage not being applied to the device, the at least one light sensor indicating an ambient light threshold is satisfied, and the at least one motion sensor indicating that motion was detected within a predetermined area, operate the at least one light engine in the auxiliary lighting operating mode using power from the at least one rechargeable battery responsive to the at least one motion sensor detecting motion,
wherein the shield is configured to block up to 27 steradians of the field of view of the at least one motion sensor, and
wherein the lighting device is configured to selectively be coupled to the line voltage via a remote switch, when the lighting device is coupled to the line voltage, the control unit is configured to cause the one or more light engines to be operated in the first operating mode and to cause the rechargeable battery to be recharged and when the lighting device is not coupled to the line voltage, the control unit is configured to activate the at least one light sensor and the control unit is configured to active the at least one motion sensor responsive to the at least one light sensor being triggered.

20. The device of claim 19, wherein the control unit is configured to stop operating the at least one light engine in the auxiliary lighting operating mode after a predetermined time period has elapsed since operation of the at least one light engine in the auxiliary lighting operating mode was initiated.

21. The lighting device of claim 1, wherein the at least one motion sensor is a microwave motion sensor and the lighting device further comprises a housing configured for mounting the lighting device to a surface, wherein the one or more light engines, the at least one rechargeable battery, the at least one motion sensor, the shield, and the control unit are disposed within a volume defined at least in part by the housing, and the shield is disposed between the at least one motion sensor and the housing.

22. The lighting device of claim 1, wherein the control unit is configured to operate the one or more light engines to provide light of a first color temperature when the one or more light engines are operated in the first operating mode and to provide light of a second color temperature when the one or more light engines are operated in the second operating mode, wherein the first color temperature is different from the second color temperature.

23. The lighting device of claim 9, further comprising a voltage converter configured to convert an alternating current electrical signal received via the line voltage to a direct current electrical signal and provide the direct current electrical signal to the additional component.
